(19) United States
(12) Patent Application Publication
(10) Pub. No.: US 2002/0026354 A1
(43) Pub. Date: Feb. 28, 2002

(54) Method and system for exchange points

(76) Inventors: Nobuhiro Shoji, Tokyo (JP); Hisaya Shirane, Tokyo (JP); Tetsuo Hanakata, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/754,086

(22) Filed: Jan. 5, 2001

(30) Foreign Application Priority Data
Aug. 25, 2000 (JP) 2000-254965

(51) Int. Cl. G06F 17/60

(52) U.S. Cl. 705/14

(57) ABSTRACT

A system and method making use of a network to exchange points issued by various companies. This invention makes use of a network to allow consumers to exchange their points issued by one source for use at a minimum of one website for points issued by and for use at a minimum of at least one other website, following reviewing the exchange rates set between the two kinds of issued points. The site at which this exchange transaction takes place has a database of its own as would both issuing sites make use of databases to monitor the proper holder of or verify the value of various issued points. Points are then transferred at rates set by the exchange transaction site according to agreements reached with the issuing companies. Customers are then enabled to use the points that they acquire by exchange.

### BACKGROUND OF THE INVENTION

1. Field of the Invention

The present invention relates to electronic commerce, and, more particularly, to a method and system for allowing customers to exchange points issued for use in electronic commerce or other uses.

2. Description of the Related Art

The Internet has allowed consumers to directly access information on companies and their products, in addition to transacting purchases using credit cards and other means. Companies with websites or which advertise on the websites of others appreciate that the Internet therefore presents a great opportunity to market to Internet users and make sales on-line. The distribution of coupons is a key component in such marketing plans. The ability of a company to attract consumers by distributing coupons and deliver other rewards systems is an essential competitive aspect that companies must master to succeed in Internet commerce.

To date, it has been difficult for point service consumers to convert their points from one company's points to those of another company.

“Points” are units which can be used to purchase goods, obtain services, earn prizes of various kinds in addition to many other uses. Said points are similar in effect to coupons, vouchers, gift certificates or similar payment related mechanisms and are often used in customer reward or incentive systems.

Consumers wishing to make purchases or payments to many sites could buy electronic money to use in paying for services via the Internet at a number of sites, however, this is not the same as points in that electronic money would have to be purchased by the consumer from an electronic money provider to be used.

Alternatively, credit card payments can be made by consumers however, this too would involve payment from said consumer. Rather than buying electronic money, customers often prefer to receive coupon type discounts that make products and services cheaper, said discounts costing the consumer nothing to obtain. Consumers' desire to exchange points is not addressed by services to date however.

A problem by company site operators is the acquisition of information about what consumers wish to buy that said company does not offer.

### SUMMARY OF THE INVENTION

The present invention addresses these and other problems.

This invention relates to a method and system for allowing consumers to exchange points issued to them by companies. More particularly, the present invention allows the user to convert their points from those issued by one company to points which can be used in making purchases from another company.

Points can be issued to consumers for use on a network system such as the internet.

Such points are often issued to encourage the consumer to make a purchase from their company or for many other possible reasons.

The present invention allows consumers who have received such points to convert said points to the points used by another company.

This is carried out by converting the points at a set point conversion rate to an intermediate point value which is then converted at a set point conversion rate to the points ultimately sought by the consumer holding points originally.

A further benefit of the present invention is that the point provider can request that a time limit be set for the use of certain points issued to the consumer.

The company can therefore use this function to allocate the amount of points that they wish used for a particular period, such as summer clothing sales, and thereby prevent the points from being used in buying clothes in the fall.

This overcomes the difficulties that companies face in not only setting an advertising budget for a particular time period but also the difficulty in trying to target a certain group of customers depending on the season without having consumers from a prior season whom may comprise a different target group affect the results.

A further benefit of the present invention to companies is that where they agree to allow their points to be converted to points issued by other companies and said other company agrees to accept such conversion, the point exchange server can report to the company initially issuing the points, what points the consumer converted said points into.

Thereby, the company initially issuing the points can use such report to consider offering new services so that a consumer will spend all of the issued points on buying products of the point issuing company, not another company.

In other words, information on consumer needs can be received and acted on by a company issuing points.

Embodiments of the present invention are directed to a method and system for allowing consumers to convert the points that they have accrued to points which can be used in transactions with other companies.

According to the present invention consumers can exchange points for use with companies other than said points' issuing company or said points' designated company by means of a communication network.

Companies which agree to allow their points to be converted to other points may also use the present invention to allow their point recipients to convert points with minimal effort on the part of the company issuing the points. Said companies may also use the present invention to obtain information on their clients needs.

### BRIEF DESCRIPTION OF THE DRAWINGS

FIG. 1 is a functional block diagram illustrating an exemplary preferred embodiment of the present invention;

FIG. 2 is an explanatory diagram illustrating an example of the general configuration according to another embodiment of the present invention;

FIG. 3 is an explanatory diagram illustrating an exemplary configuration within a card;

FIG. 4 is an explanatory diagram illustrating exemplary functions of a server;

FIG. 5A is a flow chart illustrating an exemplary processing procedure;

FIG. 5B is a flow chart illustrating an exemplary processing procedure; and

FIG. 6 is an explanatory diagram illustrating an information recording medium of the present invention.

### DESCRIPTION OF THE PREFERRED EMBODIMENTS

Hereinbelow, a detailed description will be given of preferred embodiments of the present invention with reference to the accompanying drawings.

(First Embodiment)

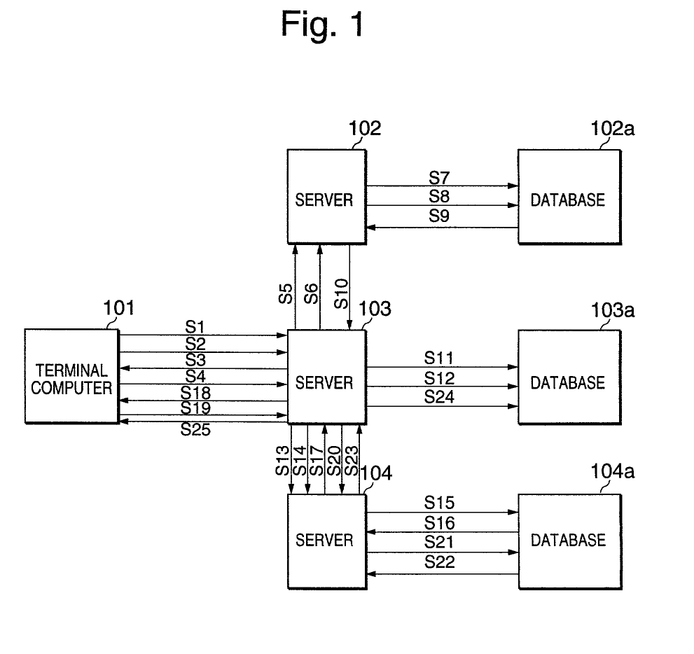

The preferred embodiment of the present invention is carried out as appears in FIG. 1. FIG. 1 includes a terminal computer 101, server 102, an associated database 102a to server 102, server 103, associated database 103a of server 103, server 104 and associated database 104a of server 104.

Terminal computer 101 could be any computer which possesses Internet related capabilities, such as an iMac, IBM compatible desktop or laptop computer, palm computer, cell phone or similar computer.

Servers 102, 103 and 104 can be commercial servers such as those made by Sun Microsystems or other servers for use in providing Internet related services such as hosting interactive web pages and other Internet services. In a preferred embodiment of the present invention, databases 102a, 103a and 104a can be commercial databases located in separate servers from servers 102, 103 and 104 capable of connection with and use by Internet servers in sending, receiving and recording information.

Databases 102a, 103a and 104a can also be contained in servers 102, 103 and 104.

Consumers use terminal computer 101 to form a communication link with server 103(S1). Server 103 being capable of performing point exchange.

Consumer either inputs into a communication box the type of points that they possess and may wish to convert or selects from the displayed information what kind of points for which they wish to see the point conversion rate.

In a preferred embodiment of the present invention, consumer may input various kinds of points which may have set time limits for use or special naming for different classes of points offered in relation to transactions with the same company.

In the case of input, terminal computer 101 communicates to server 103, the input data(S2).

Server 103 responds by providing the exchange rate for such points to other points(S3) and allows consumer to input the number of points that they wish to convert and identification information relating to their ownership of such points as needed(S4).

Server 103 is equipped to be able to form communication links with other servers 102 and 104.

For purposes of the present invention, other servers 102 and 104 are those, which belong to point issuing companies.

Server 103 then forms a communication link with server 102(S5) and communicates a query requesting confirmation of ownership of points input by consumer from terminal 101(S6).

Server 102 then communicates with database 102a(S7) to confirm the ownership of points(S8) and assign ownership to the company at server 103(S9).

In the event of points being confirmed as belonging to consumer according to identification information received from server 103, ownership of points is recorded as belonging to server 103 and server 102 communicates to server 103 information necessary for server 103 to utilize such points(S10).

Server 103 then communicates with database 103a information necessary for server 103 to make use of points(S11).

Server 103 also communicates to database 103a that consumer is now the owner of points administered by server 103, the amount or number of points having been calculated by server 103 based upon exchange rate previously shown to consumer(S12).

Server 103 then forms a communication link with server 104(S13).

Server 103 then communicates a request to server 104 to acquire a set amount or number of points from server 104(S14), number being the result of calculation by server 103.

Server 104 then communicates to database 104a to confirm that points are available in the sought amount and(S15), if so, indicates to server 104 that points are available(S16).

Server 104 then communicates a request to server 103 that identifying information be selected by consumer for use of points of server 104(S17).

Server 103 then communicates to terminal 101 a request for selecting identifying information(S18) and allows consumer to input from terminal 101 identifying information selected(S19). Server 103 then relays information to server 104(S20).

Server 104 then records into database 104a identifying information(S21) and assigns amount or number of points to consumer.

Upon completion of assignment of points of server 104(S22), server 103 then communicates to database 103a(S23) that assignment of points of server 103 to consumer should be erased(S24).

Server 103 then communicates information to terminal 101 confirming consumer's ownership of points of server 104 and loss of ownership of points of server 102(S25).

In a preferred embodiment of the present invention, consumer may provide identifying information to be used in relation to points sought of server 104 as a part of their initial request for conversion of points of server 102 to points of server 104.

Also, in the preferred embodiment of the present invention, point issuing servers such as server 102 and server 104 can be set to have no limit on the number of points that they will recognize from another site, thereby obviating the step of confirming whether sufficient points are available from the issuing server of the points sought.

The present invention may also be used to convert issued points belonging to the consumer to points of the converting server, server 103 to be kept in an account for future conversion into other points or for use at the site hosted by server 103 or related sites which recognize the points of server 103.

As indicated above, point issuing servers can have their points customized into different names, categories, and validity time-spans of points as well as other similar designations which will then appear in such form on server 103.

In the event that points of a set time limit are converted to points of server 103, the points of server 103 may be set to have a time limit as well.

According to the present invention consumers can exchange points for use with companies other than said points' issuing company or said points' designated company by means of a communication network.

Companies which agree to allow their points to be converted to other points may also use the present invention to allow their point recipients to convert points with minimal effort on the part of the company issuing the points. Said companies may also use the present invention to obtain information on their clients needs.

[Second Embodiment]

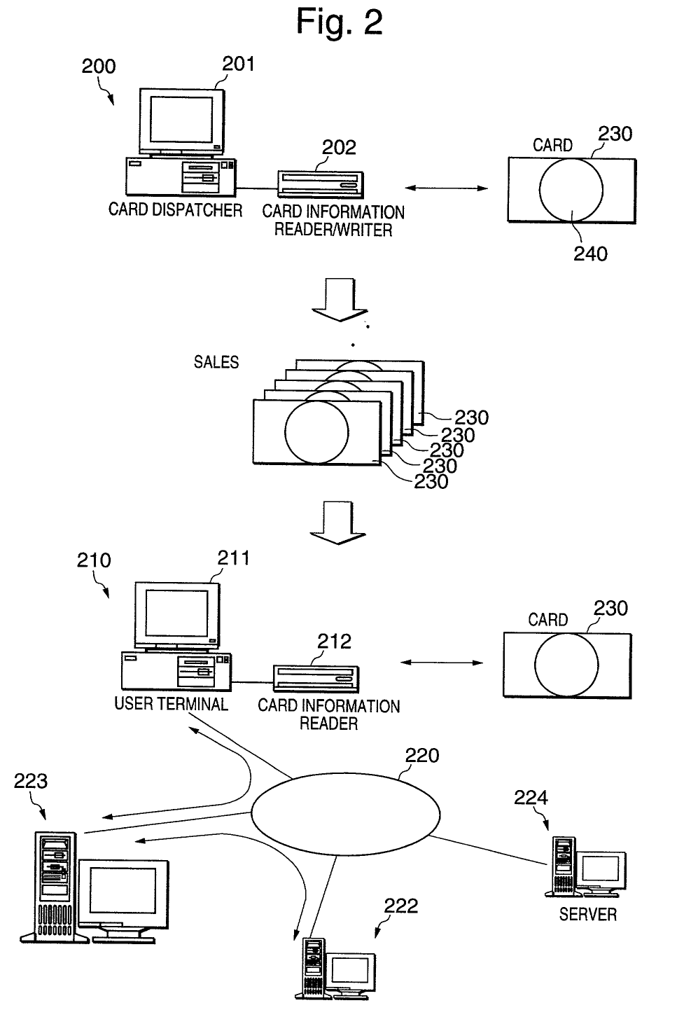

Next, a second embodiment according to the present invention will be described with reference to FIG. 2.

The following description will be made only on differences between the first embodiment and the second embodiment, while omitting the description on the configuration substantially similar to the first embodiment.

FIG. 2 is an explanatory diagram illustrating the concept of a point card system in the second embodiment.

The point card system of this embodiment illustrates an example in which the P-points converted in the P-site server disclosed in the first embodiment are stored in a point card.

First, in FIG. 2, the point card system comprises a card dispatcher 200 for dispatching a P-point card 230 which is a point card in a P-site; and the prepaid card 230 which is dispatched by the card dispatcher 200.

The card dispatcher 200 comprises a card information reader/writer 202 for writing and reading information into and from an information recording medium 240 formed in the card 230; and a computer 201 provided with a driver for driving the card information reader/writer 202.

The card 230 has the information recording medium 240 embedded in its body for recording information. The information recording medium 240 may be, for example, CDROM, floppy disk, MO, ZIP, and so on.

Further, the card 230 itself may be configured as an information recording medium.

After a variety of information has been written into the information recording medium 240 in the card 230 using the card dispatcher 200 as mentioned, a plurality of the cards 230 are sold in convenience stores and so on.

In this event, a variety of point cards 230 have been provided in accordance with desired numbers of points, for example, 1000P, 5000P, 10000P and so on, so that the user may purchase a point card of the amount suitable for him.

As the user purchases a desired point card 230, the card 230 can be read using a user terminal 210 such as a normal personal computer.

Specifically, the user terminal 210 comprises a card information reader 212 for reading the card 230; and a computer 211 provided with a driver for driving the card information reader 212.

In the illustrated example, the user terminal 210 is connected to a network 220, and connected to the aforementioned P-site server 223, server 222, server 224 through the network 220.

The user inserts the card 230 into the card information reader 212 to display a variety of information on a display screen of the computer 211.

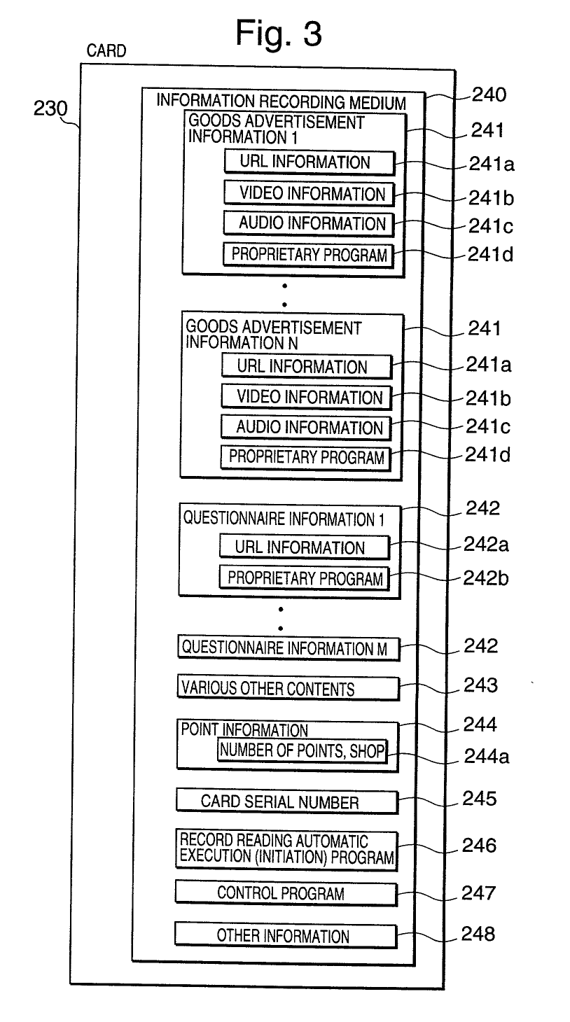

Here, the contents of information recorded in the card 230 are explained with reference to FIG. 3.

The information recording medium 240 in the card 230 contains a plurality of pieces of goods advertisement information 241 related to each of the shops; a plurality of pieces of questionnaire information 242 related to each of the shops; a variety of other contents 243; point information 244 related to points in the P-site; a card serial number 245 unique to the card; a record reading automatic execution (initiation) program 246 for automatically executing (initiating) record reading for automatically displaying the contents on the display screen when the card is inserted; a control program 247 for controlling these components; and other information 248.

The goods advertisement information 241 is comprised of URL (Uniform Resource Locator) information 241a which is independent address information unique to this advertisement information, and describes the address of a home page hosted by the advertiser on the P-site server; video information 241b and audio information 241c which represent the contents of advertisement; and a proprietary program 241d including a program for prompting the computer 211 to calculate the number of points, and so on.

The questionnaire information 242, like the goods advertisement information 241, is comprised of URL information 242a which is unique independent address information, and a proprietary program 242b.

The point information 244 in turn includes the number of points possessed in this card, information on a store in which the card is sold, and so on.

The other information 248 preferably includes, for example, program information for prompting a consumer to browse advertisement information upon reading the information recording medium 240, and prompting the computer 211 to add service points to the number of points previously allocated to the card itself when accessing to a server corresponding to URL information;

program information for prompting the consumer to browse questionnaire information upon reading the information recording medium 230, and transmitting replay information to the questionnaire information to a server corresponding to URL information when accessing to the server, and prompting the computer 211 to add service points to the number of points previously allocated to the card itself; program information for prompting the consumer to browse one or both of advertisement information and questionnaire information upon reading the information recording medium 240, and prompting the computer 211 to add first service points to the number of points previously allocated to the card itself when accessing to a server corresponding to first URL information, and to add second service points to the number of points previously allocated to the card itself when accessing a server corresponding to second URL information; and so on.

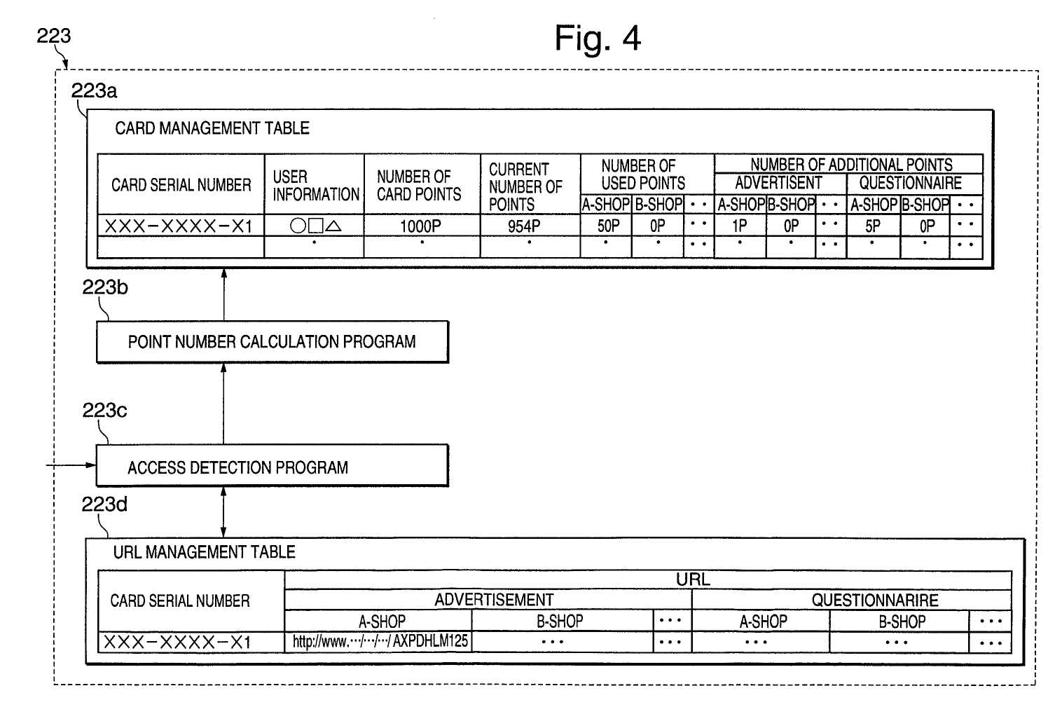

This embodiment implements a feature of adding the number of points in the card 230 as described above, when the card 230 is inserted to display the advertisement and questionnaire information on the user terminal 210, and the consumer accesses URL indicated by an advertisement or a questionnaire. For this purpose, the P-site server 223, which is the destination of URL, is provided with a variety of processing means (processing programs) as illustrated in FIG. 4.

Specifically, the P-site server 223 comprises a card management table 223a for managing all dispatched cards; a point number calculating program 223b which is point number calculation processing means for calculating the number of points in response to an access from the user terminal 210 to update the number of points in the card management table 223a; a URL management table 223d which stores URL information possessed by each goods advertisement information and each questionnaire information for each of the shops uniquely and independently on each card; and an access detection program 223c which is an access detection processing means for comparing, based on an access from the user terminal 210, URL information and a card serial number on the URL management table 223d with URL information, to which the access is specified, to authenticate a user, and for prompting the computer 211 to start executing the point number calculation program 223b only when a match results from the comparison.

The card management table 223a, in accordance with each card serial number uniquely appended to a dispatched card, is corresponded to user information; the number of card points as indicated by the rate in the P-site when the card was dispatched; the current number of points indicative of the current total number of points; the number of used points which have been used in each shop; the number of additional points in accordance with each shop which is added when the consumer browses an advertisement of the shop; the number of additional points in accordance with each shop which is added when the consumer responds to a questionnaire; and so on.

The URL management table 223d manages URL information unique to each goods advertisement information and questionnaire information.

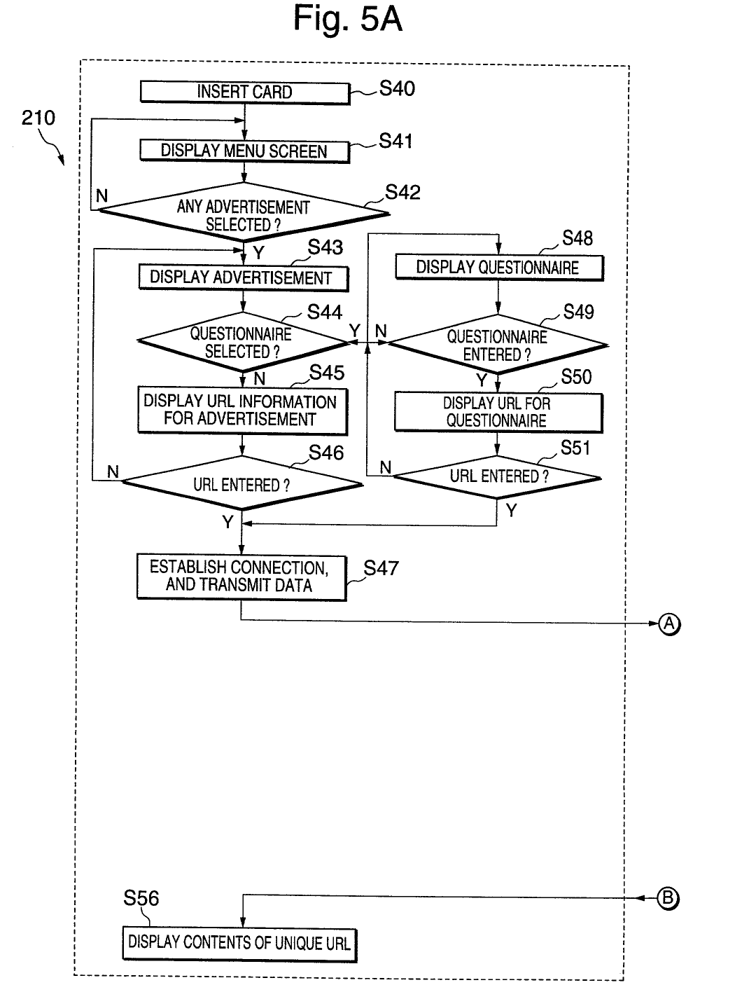

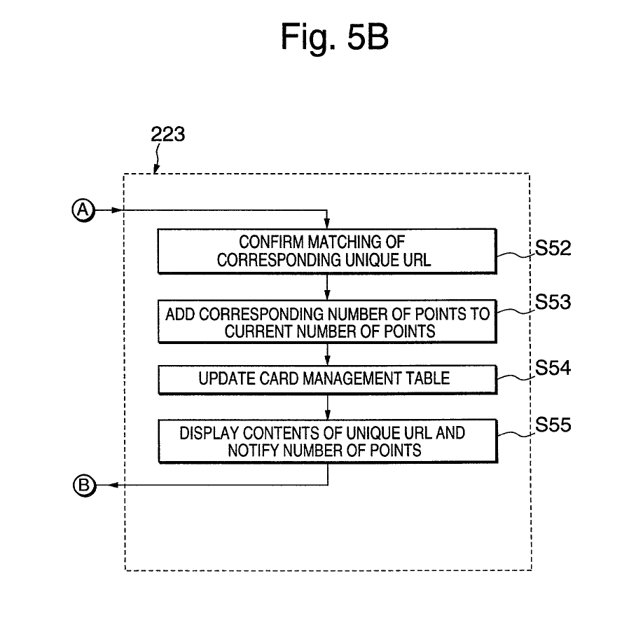

Next, referring to FIG. 5A, 5B, description will be made on the concept of a processing procedure from an access from a user terminal to the addition of points on the server side in the point card system configured as described above.

First, as the card 230 is inserted into the card information reader 212 of the user terminal 210 (S40), the aforementioned automatic execution program in the information recording medium 240 of the card 230 instructs the user terminal 210 to display a menu screen on the display screen of the computer 211 (S41).

Next, as the user selects any of advertisements displayed on the menu screen through a manipulation such as clicking (S42), the selected advertisement is displayed (S43).

Next, assuming that the selected advertisement has a number of questionnaire information related to the advertisement, as the user selects certain questionnaire information (S44), the selected questionnaire information is displayed (S48).

On the other hand, when the user does not select any questionnaire information or when the advertisement has no questionnaire information, URL information for advertisement, uniquely allocated to the advertisement, is displayed on the advertisement display screen or on the next screen, or the like (S45).

As the user enters the displayed URL information for advertisement, a connection is established between the user terminal 210 and the P-point server 223 (S47).

Next, on the server 223, an authentication process is performed for determining whether or not the URL information for advertisement entered at the user terminal matches URL information corresponding to the card having the serial number, which has been previously registered in the URL management table in the server 223 when the card was dispatched (S52).

When the URL information matches, a corresponding number of points (for example, plus 1P for browsing an advertisement) is added to the current number of points of the user corresponding to the card serial number, for example, 1000P (S53).

Next, the value of the number of points in the card management table is updated based on the number of additional points (S54).

Then, a notification is made so that the content corresponding to the URL is displayed on the user terminal 210, while the updated number of points is also displayed on the user terminal 210 (S55).

In this way, the unique URL content is displayed on the computer 211 of the user terminal 210 (S56).

On the other hand, if a number of questionnaire information is displayed and the use enters selected questionnaire information at the aforementioned S48, URL information for the questionnaire is displayed on a questionnaire display screen or on the next page, or the like (S50).

Then, as URL for the questionnaire is entered (S51), similar processing to that at S47-S56 is performed.

It should be noted however that in this case, unlike the processing for an advertisement, unique URL for questionnaire is accessed, and information on the result of a questionnaire replied by the user is transmitted from the user terminal 210 to the server 223.

Also, when the number of points is added at S53, if a corresponding number of points has been set to plus 5P, for example, this 5P is added when the user replies to the questionnaire.

By thus setting the number of additional points to a different value in accordance with the category of information, it is possible to encourage the user to use the points.

Similarly, as the user performs desired manipulations to advertisements and questionnaires of other shops, some points are added or not to the card.

Of course, it goes without saying that a purchase at an associated shop results in a decrease in the number of points.

Further additionally, the P-site server may charge an extra advertisement fee or a commission in accordance with an number of additional points, each time the number of points is added, from an advertiser of an advertisement for which the number of points is added.

In this way, an income can be ensured in the form of commission, while prompting advertisers to acquire users, in addition to an advertising revenue at the time of the site participation contract.

[Third Embodiment]

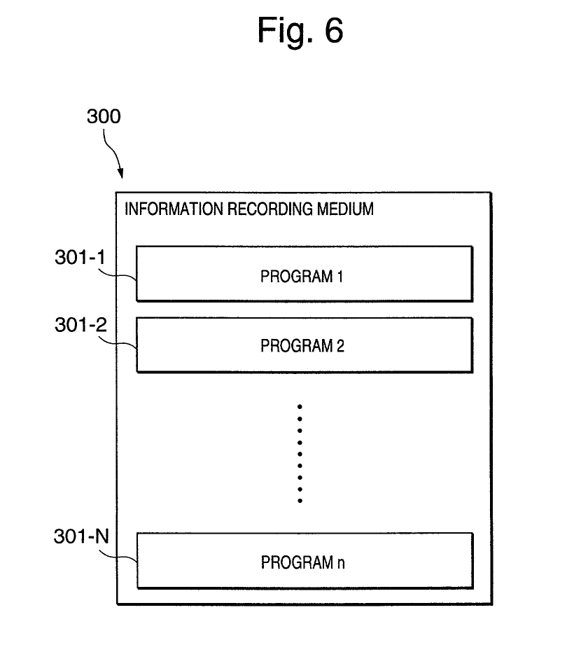

Next, a third embodiment of the present invention will be explained with reference to FIG. 6.

FIG. 6 illustrates a recording medium which has recorded thereon processing programs processed by the server of the point exchange system in the aforementioned first embodiment; an information recording medium, not in the form of card, which has recorded thereon the contents of the information recording medium contained in the card in the second embodiment; an information recording medium which has recorded thereon processing programs processed by the server; or a combination of any or all of these programs.

This information recording medium 300 may be any of a variety of media, for example, a hard disk, CD-ROM, DVDRAM, DVDROM, MO, ZIP, and so on.

The information recording medium 300 includes program information 301-1 for prompting the consumer to access a first server (see the first embodiment) which provides the consumer with a service of exchanging the points through a terminal; a program information 301-2 for displaying an exchange rate between the consumer's points and at least one kind of points in another form; program information 301-3 for prompting the consumer to select points which the consumer wants to exchange, from available points, using the first server; program information 301-4 for prompting the consumer to notify the first server that the consumer exchanges the consumer's points to the available points; program information 301-5 for prompting the consumer to enter authentication information that the consumer utilizes the consumer's points; program information 301-6 for exchanging the consumer's points to the available points based on the exchange rate; and program information 301-7 for providing the consumer with the available points.

Further, additionally or separately, the information recording medium 300 includes program information 301-8 for establishing a communication link between the first server and the second server which has issued points of a enterprise; program information 301-9 for establishing a communication link between the first server and a third server which issues points requested by the consumer or which can issue the points; program information 301-10 for transmitting authentication information for the points to the second server; program information 301-11 for allowing the second server to assign ownership of the consumer's points to the first server; program information 301-12 for transmitting a request from the first server to the third server to assign requested points; program information 301-13 for transmitting a request for recording the novel authentication information when the available points are assigned from the first server to the third server; and program information 301-14 initiated when the assignment has been executed without problem to receive from the third server a confirmation that the available points have been assigned.

In this way, the aforementioned system and so on may be recorded on an information recording medium.

While the apparatus and method according to the present invention have been described in connection with several specific embodiments thereof, a variety of modifications can be made by those skilled in the art to the embodiments described in the specification without departing from the spirit and scope of the present invention.

For example, while the respective embodiments described above have shown that the points in the point card are exchange points in the P-site, they may be simple points.

Preferably the points included would include points for prepaid Internet use of certain websites, mileage from frequent flier programs, coupon type points, points issued by stores to customers and numerous other types of points.

Further, it goes without saying that the present invention also encompasses a combination of the foregoing respective embodiments, or a combination of the respective embodiments and modifications thereto.

What is claimed is:

1. A method for at least one consumer to exchange points issued by various sources comprising the steps of:
accessing a first server,
displaying an exchange rate of points between said consumer's points and at least one other form of points,
allowing said consumer to select which points they wish to convert said consumer's points into of any points available by use of said first server,
allowing said consumer to inform said first server of said consumer's decision to convert said consumer's points to said points available,
allowing said consumer to input any identifying information that consumer uses said consumer's points,
allowing said consumer to provide information that said consumer wishes to use as identifying information in relation to said points available,
converting said points of said consumer to points that said available points based on said exchange rate, and
providing said consumer with said available points.

2. The method of claim 1, wherein the step of converting further comprises:
forming a communication link between said first server and a second server which issued said consumer's points,
forming a communication link between said first server and a third server which issued or can issue points which said consumer seeks,
communicating to second server said identifying information of said points,
allowing said second server to assign ownership of said consumer points to said first server,
communicating from said first server to said third server a request to assign said sought points for use in relation to said third server,
communicating from said first server to said third server a request to
record said new identifying information in assigning said available points, and
receiving from said third server confirmation that said available points have been assigned in the event that assignment is successfully carried out.

3. The method of claim 1, wherein points comprise points purchased using a credit card.

4. The method of claim 1, wherein points comprise mileage.

5. The method of claim 1, wherein points comprise units for payment of pre-paid access to network sites.

6. The method of claim 1, wherein said accessing step is conducted via a network.

7. The method of claim 1, wherein said accessing step is conducted via the Internet.

8. The method of claim 1, wherein further comprising the steps of:
providing points with time limitations on their use and
erasing information of ownership of said points with time limitations upon expiration of said time limitation.

9. A system for exchanging points comprising: at least one server from which a point transaction can occur which is connected to a communication network said one server having access to a memory,
at least one second server capable of use in issuing, recording and communicating information on consumer's points said second server having access to a second memory,
at least one third server capable of use in issuing, recording and communicating information on said consumer's points said third server having access to a third memory,
at least one terminal computer connected to a communication network and capable of sending and receiving information,
wherein a communication link is formed between said terminal computer
and said first server, said terminal computer can be used to input information on said consumer points, said first server in response indicates the kinds and amounts of points available to consumer, consumer can then indicate which points they wish to convert their points to and provide information for use in identifying said consumer points as being those of said consumer, said first server then forming a communication link with and communicating with said second server and said third server to exchange said consumer points to issued points of said third server.

10. The system of claim 9 further comprising:
said first memory comprising at least one database to and from which points issuance related information can be recorded and retrieved for said one server,
said second memory comprising at least one second database to and from which points issuance related information can be recorded and retrieved for said second server, and
said third memory comprising at least one third database to and from which points issuance related information can be recorded and retrieved for said third server
wherein communication links between each respective database and
each respective server are utilized to confirm, assign and record said consumer points as required to exchange points.

11. The system of claim 9 further comprising:
at least one database at which points are stored in the form of mileage.

12. The system of claim 9 further comprising: at least one server which assists in issuing of points in exchange for payment by credit card.

13. The system of claim 9 further comprising:
at least one server and at least one database which issue points with time limitation on their use and ownership of said points with time limitations is erased upon expiration of said time limitation.

14. The system of claim 9 further comprising:
at least one server and at least one database which can issue points of different classes and different names.

15. A point card dispatched with points recorded on an information recording medium or on a prepaid card including an information recording medium, said points being exchanged in a point exchange system wherein at least one consumer exchanges points issued by a variety of sources, said point card comprising:
first information recorded on said information recording medium; and
URL information unique to said first information, previously recorded together with said first information,
wherein service points are added to a number of points previously allocated to said card itself when said consumer browses said first information when said information recording medium is read and accesses a server corresponding to said URL information.

16. A point card according to claim 15, wherein:
said first information includes a plurality of different types of second information pieces,
wherein said service points provide different numbers of points in accordance with a plurality of said second information pieces.

17. A point card according to claim 15, wherein:
said first information is advertisement information.

18. A point card according to claim 15, wherein:
said first information is questionnaire information.

19. A point card which has points issued by a source recorded on an information recording medium or on a prepaid card including an information recording medium, said point card comprising:
first information recorded on said information recording medium; and
URL information unique to said first information, previously recorded together with said first information,
wherein service points are added to a number of points previously allocated to said card itself when said consumer browses said first information when said information recording medium is read and accesses a server corresponding to said URL information.

20. A point card according to claim 19, wherein said server corresponding to said URL information is a server in a point exchange system wherein at least one consumer exchanges points issued by a variety of sources.

21. A point card according to claim 20, wherein:
said URL information is complicated information which describes directory information at a lower hierarchical level that cannot be accessed by a consumer who is unaware of said URL information.

22. A point card according to claim 20, wherein:
said server comprises means for adding the number of card points of said user as a predetermined number of service points based on said URL information entered from a user terminal.

23. A point card dispatched with points recorded on an information recording medium or on a prepaid card including an information recording medium, said points being exchanged in a point exchange system wherein at least one consumer exchanges points issued by a variety of sources, said point card comprising:
advertisement information recorded on said information recording medium;
URL information unique to said advertisement information, previously recorded together with said advertisement information; and
program information for prompting said consumer to browse said advertisement information when said information recording medium is read, and for adding service points to a number of points previously allocated to said card itself when said consumer accesses a server corresponding to said URL information.

24. A point card dispatched with points recorded on an information recording medium or on a prepaid card including an information recording medium, said points being exchanged in a point exchange system wherein at least one consumer exchanges points issued by a variety of sources, said point card comprising:
questionnaire information recorded on said information recording medium;
URL information unique to said questionnaire information, previously recorded together with said questionnaire information; and
program information for prompting said consumer to browse said questionnaire information when said information recording medium is read, and for transmitting replay information for said questionnaire information to said server and adding service points to a number of points previously allocated to said card itself when said consumer accesses a server corresponding to said URL information.

25. A point card dispatched with points recorded on an information recording medium or on a prepaid card including an information recording medium, said points being exchanged in a point exchange system wherein at least one consumer exchanges points issued by a variety of sources, said point card comprising:
advertisement information recorded on said information recording medium;
first independent URL information unique to said advertisement information, previously recorded together with said advertisement information;
questionnaire information recorded on said information recording medium;
second independent URL information unique to said questionnaire information, previously recorded together with said questionnaire information; and
program information for prompting said consumer to browse either one or both of said advertisement information and said questionnaire information when said information recording medium is read, for adding first service points to a number of points previously allocated to said card itself when said consumer accesses a server corresponding to said first URL information, and for adding second service points to the number of points previously allocated to said card itself when said consumer accesses a server corresponding to said second URL information.

26. An information recording medium having recorded thereon a program for providing a point exchange service for allowing at least one consumer to exchange points issued by a variety of sources, said information recording medium comprising:
program information for prompting said consumer to access a first server which provides said point exchange service using a terminal;
program information for displaying an exchange rate between said consumer's points and at least one type of points in another form;
program information for prompting said consumer to select points which said consumer wants to exchange from available points using said first server;
program information for prompting said consumer to notify a decision that said consumer exchanges said consumer's points to said available points for said first server;
program information for prompting said consumer to enter authentication information indicating that said consumer utilizes said consumer's points;
program information for converting said consumer's points to said available points based on said exchange rate; and
program information for providing said consumer with said available points.

27. An information recording medium according to claim 26, further comprising:
program information for establishing a communication link between said first server and a second server which has issued points of an enterprise;
program information for establishing a communication link between said first server and a third server which issues points requested by said consumer or which can issue the points;
program information for transmitting authentication information for said points to said second server;
program information for allowing said second server to assign ownership of said consumer's points to said first server;
program information for transmitting a request for assigning requested points from said first server to said third server;
program information for transmitting a request for recording said novel authentication information when said available points are assigned from said first server to said third server; and
program information initiated when the assignment has been executed without problem to receive from said third server a confirmation that the available points have been assigned.
